(19) United States
(12) Patent Application Publication
(10) Pub. No.: US 2002/0075803 A1
(43) Pub. Date: Jun. 20, 2002

(54) Method and apparatus for dynamic optimization of a multi-service access device

(76) Inventors: John Zaharychuk, Simi Valley, AZ (US); John R. Morris, Simi Valley, CA (US); Adnan A. Onart, Boston, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/739,731

(22) Filed: Dec. 18, 2000

(51) Int. Cl. H04L 12/56

(52) U.S. Cl. 370/231; 370/412

(57) ABSTRACT

The present invention provides for the dynamic optimization of a multi-service access device in response to the current mix of data traffic being presented to the access device. The access device includes an analyzer and an optimizer. The analyzer is used to analyze a current mixture of a plurality of different data traffic types to create analyzer data. The optimizer is coupled to the analyzer. The optimizer is used to optimize system parameters of the access device, based upon the analyzer data, such that the access device is continuously dynamically optimized in response to the changing mixtures of the different data traffic types presented to the access device.

### BACKGROUND

1. Field of the Invention

This invention relates to communication systems. In particular, the invention relates to the field of transmitting data over data networks, and more particularly, to a method and apparatus for the dynamic optimization of a multi-service access device in response to the current mix of data traffic being presented to the multi-service access device.

2. Description of the Related Art

Telecommunications, which has historically only been involved with analog voice and fax connectivity, is increasingly merging with data communications/data networking, which has historically only been involved with digital data connectivity. The merging of the telecommunications and data communications environments has occurred because of the emergence of the Digital Signal Processor (DSP). DSPs allow voice, video, fax and other analog signals to be processed into a variety of digital formats. With the right software, a DSP can convert analog voice and fax into digital data for transport over data networks. Because DSPs have fallen substantially in price, the development of new types of hybrid networking environments—voice/data integrated networks—are rapidly being developed. This sort of functionality has been incorporated in routing/switching devices that connect a plurality of networks to one another and further perform forwarding of packets between the connected networks. Today, multi-access service devices, such as multi-access routers/switches, integrate voice, video, and data for transmission across connected networks. It is particularly important that these voice/data integrated networks transport voice/data packets or cells as reliably and efficiently as possible.

Unfortunately, data traffic and voice traffic routed through a multi-service access device have conflicting requirements and the optimizations presently used to handle them are effectively at odds with one another. For example, voice traffic needs low latency and high reliability. Particularly, for voice transmission and reception to be effective over a data network voice packets need to be received and transmitted consecutively with high reliability (i.e. minimal loss) and with very little delay (i.e. minimal latency and interrupts). Latency, in the receipt of voice packets causes echoes and delays. Further, when voice packets are lost, the actual real time voice conversation is likewise lost, which is unacceptable. Therefore, multi-service access devices that are statically optimized for voice typically interrupt lower priority tasks (e.g. data traffic processing) to allow for the consecutive processing of voice packets.

On the other hand, latency and reliability are not that great of a concern to the processing of data traffic. In the processing of data traffic, if a packet is delayed or lost, it is not that important because it can just be resent and then utilized; as opposed to a real time operation such as a voice conversation. The more important criterion for the processing of data traffic is high throughput. Efficient data processing requires large amounts of uninterrupted processing time where the multi-service access device can process large volumes of data traffic while taking advantage of high speed cache memory and repetitive operations. This results in great increases in efficiency for data processing. Therefore, multi-service access devices that are statically optimized for data traffic processing, typically set data traffic processing as the highest scheduling priority to the detriment of voice traffic processing.

A disadvantage of current multi-access service devices is that they are statically optimized in favor of either voice or data traffic or are optimized by attempting to pick a middle ground to make the best compromise between voice and data traffic (and are thus sub-optimal for both). For example, current multi-access service devices statically allocate predetermined percentages of bandwidth, CPU processing, and memory or cache memory to favor certain types of data traffic or voice traffic over other types of data traffic. Also, as previously discussed, current multi-access service devices statically set favored types of data traffic or voice traffic to have the highest scheduling priority. Unfortunately, these multi-access service devices operate optimally for one type of traffic mix (data or voice) but as soon as the traffic mix changes they operate sub-optimally. Additionally, some types of multi-access service devices have been designed that utilize a single static optimization based on the expected traffic mix, as well as, designed to allow the customer to re-configure and re-optimize the operation of the multi-access service device for different expected traffic mixes. However, all these solutions require advanced knowledge of the traffic mix and do not respond to the dynamic traffic patterns experienced by a multi-access service device in a real world operating environment.

### SUMMARY

The present invention provides for the dynamic optimization of a multi-service access device in response to the current mix of data traffic being presented to the access device. The access device includes an analyzer and an optimizer. The analyzer is used to analyze a current mixture of a plurality of different data traffic types to create analyzer data. The optimizer is coupled to the analyzer. The optimizer is used to optimize system parameters of the access device, based upon the analyzer data, such that the access device is continuously dynamically optimized in response to the changing mixtures of the different data traffic types presented to the access device.

In one embodiment, the analyzer includes a plurality of data taps, in which, each data tap is associated with a particular data traffic type to acquire information about that particular data traffic type. Further, the optimizer includes an optimizing processing unit to process the analyzer data received from the analyzer. The optimizer uses the analyzer data to generate optimized system parameters for the core processing engine of the access device such that the access device is dynamically optimized in response to changing mixtures of different data traffic types. Moreover, the optimizer can include an optimizing database that includes optimized system parameters to achieve a desired goal for different mixtures of data traffic types. The optimized system parameters can include such parameters as: scheduling priority, queue size, CPU allocation, cache memory allocation, discard priority, and message size. Of course, further optimized system parameters are also possible.

For example, when the access device is operating at night, the desired goal may be to favor a certain type of data traffic, e.g. for large file transfers, to take advantage of large amounts of uninterrupted processing time to thereby efficiently process large volumes of data traffic. This allows the access device to process this type of data traffic with very high throughput by taking advantage of high speed cache memory and uninterrupted CPU processing time to perform repetitive operations. Thus, in this instance, the optimized system parameters are set such that the scheduling priority for this type of data traffic is set to a high value, the queue size for this type of data traffic is set to a high value, CPU allocation for this type of data traffic is set to a large value, cache memory allocation for this type of traffic is set to a large value, and the discard priority for other types of data traffic is set to a high value.

However, assuming a number of voice calls suddenly need to be processed by the access device and that a desired goal is that voice calls have a higher priority than data traffic, the access device can suddenly switch to be dynamically optimized for voice calls. In this instance, the optimized system parameters can be changed such that the scheduling priority for the voice traffic is set to a high value, queue size for the voice traffic is set to a small value, CPU allocation for the voice traffic is set to a large value, and the discard priority for the other types of data traffic is set to a high value. Accordingly, the access device is dynamically optimized to favor voice traffic so that the voice traffic is more likely to get through reliably without delay or latency, while putting off the data traffic that can be processed at a later time. Thus, the access device is dynamically optimized to respond to the changing mixtures of data traffic types.

Moreover, the present invention can be used with an access device already having a fixed hardware configuration to support increased data traffic throughput at higher quality levels than access devices not using the invention. Accordingly, lower cost access devices using the present invention can provide the same performance as higher cost access devices resulting in significant cost savings.

Other features and advantages of the present invention will be set forth in part in the description which follows and the accompanying drawings, wherein the preferred embodiments of the present invention are described and shown, and in part will become apparent to those skilled in art upon examination of the following detailed description taken in conjunction with the accompanying drawings, or may be learned by the practice of the present invention. The advantages of the present invention may be realized and attained by means of the instrumentalities and combinations particularly pointed out in the appended claims.

### BRIEF DESCRIPTION OF THE DRAWINGS

The features and advantages of the present invention will become apparent from the following detailed description of the present invention in which:

FIG. 1 shows a voice and data communication system in which one embodiment of the present invention can be practiced.

FIG. 2 is a block diagram illustrating a multi-service access device of FIG. 1 in concentrator form according to one embodiment of the present invention.

FIG. 3 is a block diagram illustrating an optimizer of the multi-service access device according to one embodiment of the present invention.

FIG. 4 is a block diagram illustrating an example of a core processing engine of the multi-service access device processing an exemplary set of data traffic according to one embodiment of the present invention.

FIG. 5 is a table illustrating three different examples of how a multi-service access device can optimize system parameters of the core processing engine for exemplary sets of data traffic and the processes shown in FIG. 4, to achieve a desired goal, according to one embodiment of the present invention.

Like reference numbers and designations in the drawings indicate like elements providing similar functionality. A letter or prime after a reference number designator represents another or different instance of an element having the reference number designator.

### DETAILED DESCRIPTION

The present invention provides for the dynamic optimization of a multi-service access device in response to the current mix of data traffic being presented to the access device. The access device includes an analyzer and an optimizer. The analyzer is used to analyze a current mixture of a plurality of different data traffic types to create analyzer data. The optimizer is coupled to the analyzer. The optimizer is used to optimize system parameters of the access device, based upon the analyzer data, such that the access device is continuously dynamically optimized in response to the changing mixtures of the different data traffic types presented to the access device.

In the following description, the various embodiments of the present invention will be described in detail. The description will include certain details such as the type of data being transmitted and the protocols used. However, such details are included to facilitate understanding of the invention and to describe exemplary embodiments for implementing the invention. Such details should not be used to limit the invention to the particular embodiments described because other variations and embodiments are possible while staying within the scope of the invention. Furthermore, although numerous details are set forth in order to provide a thorough understanding of the present invention, it will be apparent to one skilled in the art that these specific details are not required in order to practice the present invention. In other instances details such as, well-known methods, types of data, protocol, procedures, components, electrical structures and circuits, are not described in detail, or are shown in block diagram form, in order not to obscure the present invention. Furthermore, the present invention will be described in particular embodiments but may be implemented in hardware, software, firmware, middleware, or a combination thereof.

In alternative embodiments, the present invention may be applicable to implementations of the invention in integrated circuits or chip sets, switching systems products and transmission systems products. For purposes of this application, the terms switching systems products shall be taken to mean private branch exchanges (PBXs), central office switching systems that interconnect subscribers, toll/tandem switching systems for interconnecting trunks between switching centers, and broadband core switches found at the center of a service provider's network that may be fed by broadband edge switches or access multiplexers, and associated signaling, and support systems and services. The term transmission systems products shall be taken to mean products used by service providers to provide interconnection between their subscribers and their networks such as loop systems, and which provide multiplexing, aggregation and transport between a service provider's switching systems across the wide area, and associated signaling and support systems and services.

In the following description, certain terminology is used to describe various features of the present invention. In general, a “communication system” comprises one or more end nodes having physical connections to one or more networking devices of a network. More specifically, a “networking device” comprises hardware and/or software used to transfer information through a network. Examples of a networking device include a multi-access service device, a router, a switch, a repeater, or any other device that facilitates the forwarding of information. An “end node” normally comprises a combination of hardware and/or software that constitutes the source or destination of the information. Examples of an end node include a Local Area Network (LAN), Private Branch Exchange (PBX), telephone, fax machine, video source, computer, printer, workstation, application server, set-top box and the like. “Data traffic” generally comprises one or more signals having one or more bits of data, address, control or any combination thereof transmitted in accordance with any chosen packeting scheme. “Data traffic” can be data, voice, address, and/or control in any representative signaling format or protocol. A “link” is broadly defined as one or more physical or virtual information-carrying mediums that establish a communication pathway such as, for example, optical fiber, electrical wire, cable, bus traces, wireless channels (e.g. radio, satellite frequency, etc.) and the like.

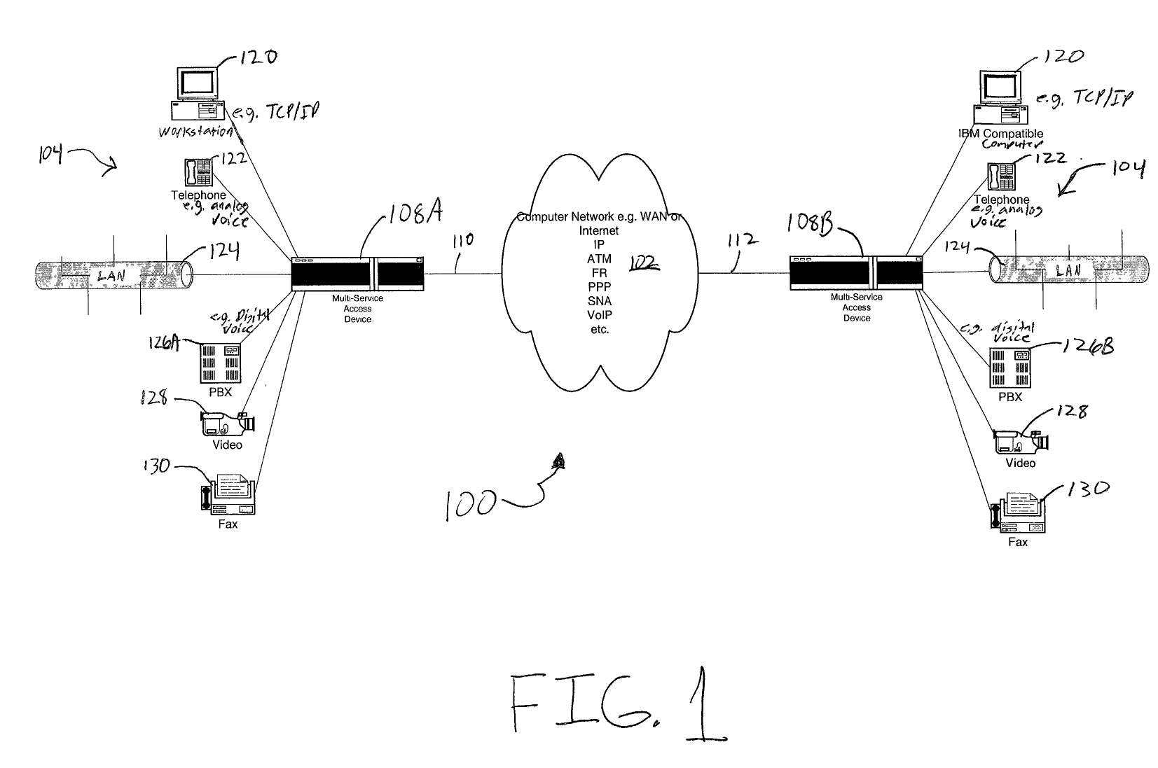

FIG. 1 shows a voice and data communication system 100 in which one embodiment of the present invention can be practiced. The communication system 100 includes a computer network (e.g. a wide area network (WAN) or the Internet) 102 which is a packetized or a packet-switched network that can utilize Internet Protocol (IP), Asynchronous Transfer Mode (ATM), Frame Relay (FR), Point-to Point Protocol (PPP), Systems Network Architecture (SNA), Voice over Internet Protocol (VoIP), or any other sort of protocol. The computer network 102 allows the communication of data traffic, e.g. voice/speech data and other types of data, between any end nodes 104 in the communication system 100 using packets. Data traffic through the network may be of any type including voice, graphics, video, audio, e-mail, Fax, text, multi-media, documents and other generic forms of data. The computer network 102 is typically a data network that may contain switching or routing equipment designed to transfer digital data traffic. At each end of the communication system 100 the voice and data traffic requires packetization when transceived across the network 102.

The communication system 100 includes networking devices, such as multi-service access devices 108A and 108B, in order to packetize data traffic for transmission across the computer network 102. A multi-service access device 108 is a device for connecting multiple networks and devices that use different protocols and also generally includes switching and routing functions. Access devices 108A and 108B are coupled together by network links 110 and 112 to the computer network 102.

Voice traffic and data traffic may be provided to a multi-service access device 108 from a number of different end nodes 104 in a variety of digital and analog formats. For example, in the exemplary environment shown in FIG. 1, the different end nodes include a computer/workstation 120, a telephone 122, a LAN 124, a PBX 126, a video source 128, and a fax machine 130 connected via links to the access devices. However, it should be appreciated any number of different types of end nodes can be connected via links to the access devices. In the communication system 100, digital voice, fax, and modem traffic are transceived at PBXs 126A and 126B which can be coupled to multiple analog or digital telephones, fax machines, or data modems (not shown). Particularly, the digital voice traffic can be transceived with access devices 108A and 108B, respectively, over the computer packet network 102. Moreover, other data traffic from the other end nodes: computer/workstation 120 (e.g. TCP/IP traffic), LAN 124, and video 128, can be transceived with access devices 108A and 108B, respectively, over the computer packet network 102.

Also, analog voice and fax signals from telephone 122 and fax machine 130 can be transceived with multi-service access devices 108A and 108B, respectively, over the computer packet network 102. The access devices 108 convert the analog voice and fax signals to voice/fax digital data traffic, assemble the voice/fax digital data traffic into packets, and send the packets over the computer packet network 102.

Thus, packetized data traffic in general, and packetized voice traffic in particular, can be transceived with multi-service access devices 108A and 108B, respectively, over the computer packet network 102. Generally, the access device 108 packetizes the information received from a source end node 104 for transmission across the computer packet network 102. Usually, each packet contains the target address, which is used to direct the packet through the computer network to its intended destination end node. Once the packet enters the computer network 102, any number of networking protocols, such as TCP/IP, ATM, FR, PPP, SNA, VoIP, etc., can be employed to carry the packet to its intended destination end node. The packets are generally sent from a source access device to a destination access device over a virtual paths or a connection established between the access devices. The access devices are usually responsible for negotiating and establishing the virtual paths are connections. Data and voice traffic received by the access devices from the computer network are depacketized and decoded for distribution to the appropriate destination end node. It should be appreciated that the FIG. 1 environment is only exemplary and that the present invention can be used with any type of end nodes, computer networks, and protocols.

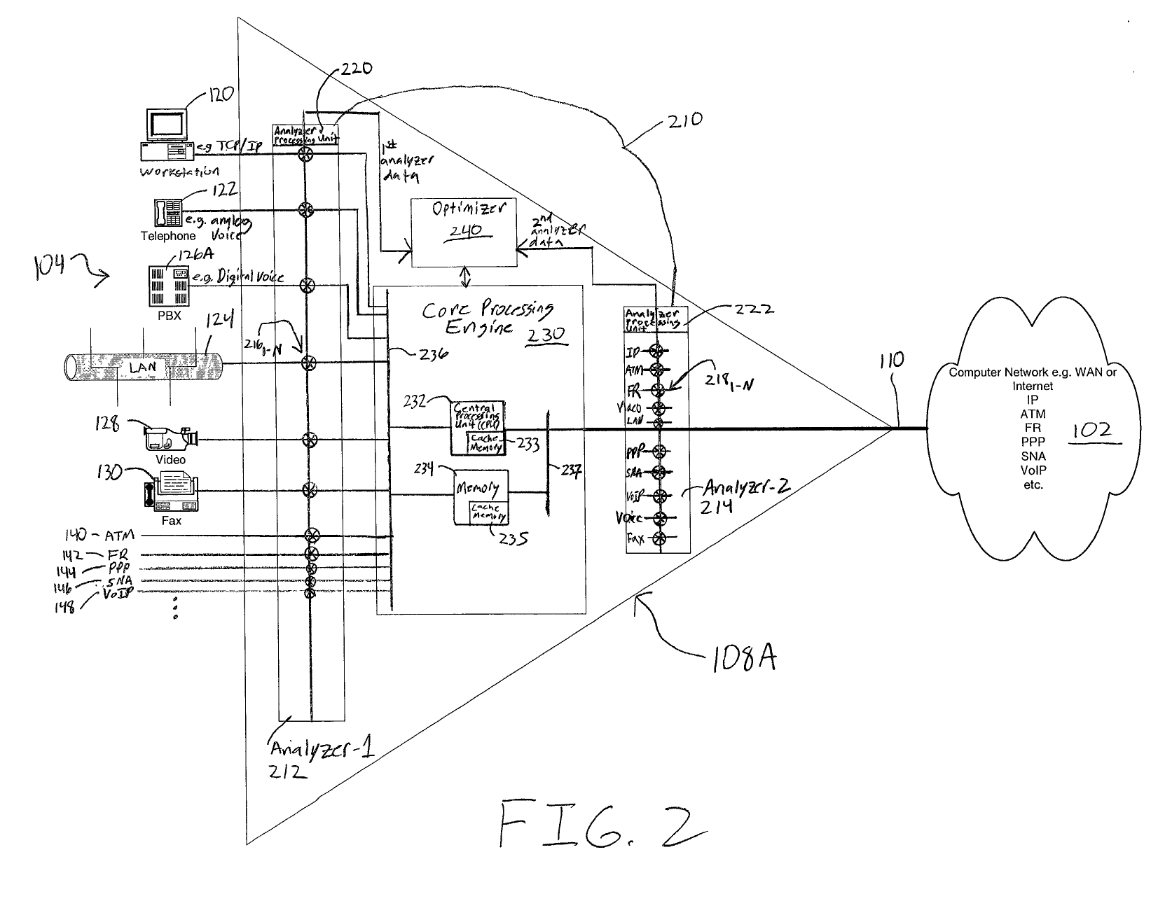

FIG. 2 is a block diagram illustrating a multi-service access device of FIG. 1 in concentrator form according to one embodiment of the present invention. The present invention provides for the dynamic optimization of a multi-service access device 108 in response to the current mix of data traffic being presented to the access device. As shown in FIG. 2, the access device 108 receives a current mixture of a plurality of different data traffic types from a plurality of different end nodes 104 as well as other data traffic inputs from the computer network 102 via network link 110. Further, the access device 108 receives local voice traffic and data traffic from the different end nodes 104 in a variety of digital and analog formats. Particularly, as shown in this example, the access device receives different data traffic types from computer/workstation 120, telephone 122, LAN 124, PBX 126, video source 128, and fax machine 130 connected via links to the access device. For example, the access device receives digital voice, fax, and modem data traffic from PBX 126, TCP/IP data traffic from computer/workstation 120, analog voice signals from telephone 122, analog fax signals from fax machine 130, video data traffic from video source 128, LAN data traffic from LAN 124, as well as, a number of other data traffic inputs such as ATM data traffic 140, FR data traffic 142, PPP data traffic 144, SNA data traffic 146, and VoIP data traffic 148. Moreover, the access device 108 receives voice traffic and data traffic for the local end nodes 104 from other end nodes across the computer network 102, as well as for other processing, via network link 110 in IP, ATM, FR, PPP, SNA, VoIP, etc., formats. It should be appreciated that these are only exemplary data traffic inputs and the present invention can be utilized with any set of data traffic inputs.

In one embodiment of the present invention, the access device 108 includes an analyzer 210, a core processing engine 230, and an optimizer 240. The analyzer 210 is used to analyze the current mixture of the plurality of different data traffic types and to create analyzer data. The optimizer 240 is coupled to the analyzer 210. The analyzer 210 provides the analyzer data to the optimizer 240. As will be discussed, the optimizer 240 is used to optimize system parameters of the access device 108, based upon the analyzer data, such that the access device is continuously dynamically optimized in response to the changing mixtures of the different data traffic types presented to the access device.

As shown in FIG. 2, the analyzer 210 includes a first analyzer 212 and a second analyzer 214. The first analyzer 214 analyzes the current mixture of the plurality of different data traffic types from the end nodes 104 and other data traffic inputs 140-148. The first analyzer 212 analyzes the current mixture to create a set of first analyzer data that it transmits to the optimizer 240. The second analyzer 214 analyzes the current mixture of the plurality of different data traffic types received from the computer network 102 via network link 110. Likewise, the second analyzer 214 analyzes the current mixture to create a set of second analyzer data that it also transmits to the optimizer 240.

The first and the second analyzer 212 and 214 each include a plurality of data taps 216_{1-N} and 218_{1-N}, respectively. Each data tap is associated with a particular data traffic type to acquire information about that particular data traffic type. The first analyzer 212 has a plurality of data taps 216_{1-N} each of which is associated with a link from one of the end nodes 104 (e.g. computer/workstation 120, telephone 122, PBX 126, LAN 124. video 128, fax machine 130) and the links from the other data traffic inputs (e.g. ATM, FR, PPP, SNA, VoIP) 140-148, respectively. The second analyzer 214 likewise has a plurality of data taps 218_{1-N} each of which is associated with a given channel of the network link 110 that carries a particular type of data traffic format/protocol or data traffic type (e.g. IP, ATM, FR, Video, LAN, PPP, SNA, VoIP, Voice, Fax). The data taps can be used to acquire information regarding, for example, packet type, packet size, class of service, priority, and the packet flow rate for each particular data traffic type. However, it should be appreciated that the data taps can be used to acquire a myriad of other types of information for various data traffic types. The data taps provide a non-intrusive method by which the access device 108 can measure the types of data traffic flowing into and out of the access device.

The first and the second analyzer 212 and 214 also each include an analyzer processing unit 220 and 222, respectively. The analyzer processing units 220 and 222 process information about the different data traffic types based upon the acquired information from the data taps 216_{1-N} and 218_{1-N} to generate first and second analyzer data, respectively, which is forwarded onto the optimizer 240. Thus, the analyzer processing units in conjunction with the data taps generate first and second analyzer data, respectively, such as the packet flow rate and the packet size for each particular data traffic type to provide the access device 108, and the optimizer 240 in particular, with a representation of the current mixture of different data traffic types flowing into and out of the access device.

The core processing engine 230 of the multi-service access device 108 includes, in this example, a central processing unit (CPU) 232 having a high speed cache memory 233, a memory 234 which may also include cache memory 235, a first bus 236 connecting the links of the end nodes 104 and other data traffic inputs 140-148 to the core processing engine, and a second bus 237 connecting the network link 110 from the computer network 102 to the core processing engine. The core processing engine 230 utilizing associated software performs common functions such as switching, routing, processing data, prioritizing data traffic flows, packetizing, depacketizing, etc., associated with typical multi-service access devices. Of course, the core processing engine 230 may also include other functionality and associated functional blocks, which are not shown herein so as not to obscure the present invention. It should be appreciated that core processing engines are well known in the art.

The optimizer 240 is used to optimize system parameters of the core processing engine 230 of the access device 108, based upon the first and second analyzer data from the first and second analyzer 212 and 214, respectively, such that the access device is continuously dynamically optimized in response to the changing mixtures of the different data traffic types presented to the access device from both the end nodes 104 and other data traffic inputs 140-148 and from the computer network 102.

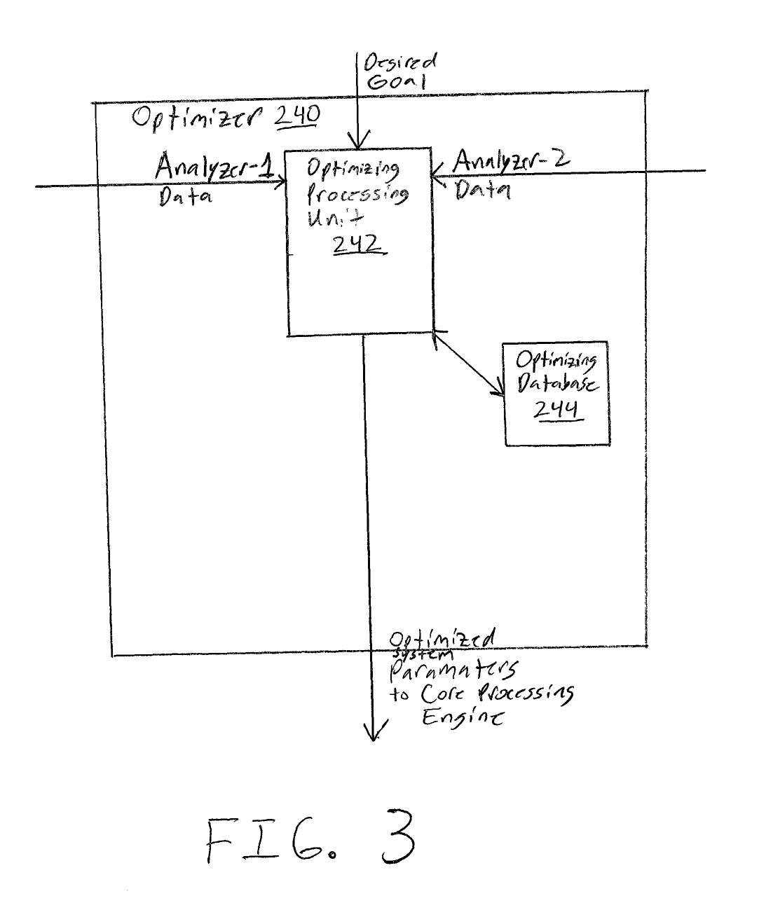

FIG. 3 is a block diagram illustrating an optimizer of the multi-service access device according to one embodiment of the present invention. As shown in FIG. 3, the optimizer 240 includes an optimizing processing unit 242 to process the first and second analyzer data from the first and second analyzer, respectively. The optimizing processing unit 242 generates optimized system parameters for the core processing engine. The optimized system parameters are transmitted to the core processing engine of the access device such that the access device is continuously dynamically optimized in response to changing mixtures of different data traffic types.

The optimizer 240 may also include an optimizing database to 244 that is coupled to the optimizing processing unit 242. The optimizing database includes optimized system parameters for different mixtures of data traffic types to achieve a desired goal. The optimized system parameters can include such parameters as: scheduling priority, queue size, CPU allocation, cache memory allocation, discard priority, message size, bandwidth allocation, scheduling granularity, cache sizes, and contents. The optimizer 240 may be programmed with a multitude of desired goals. For example, a desired goal may be to favor a certain type of data traffic at night (e.g. for large file transfers), over other types of data traffic (e.g. Voice, TCP/IP, FR, etc.) to take advantage of large amounts of uninterrupted processing time to thereby efficiently process large volumes of data. As another example, the desired goal may be to favor a certain type of data traffic (e.g. financial transaction data traffic via SNA) over all other types of traffic at night, except voice, such that voice is the data traffic with the highest priority. Thus during the processing of financial data traffic at night, if a number of voice calls suddenly need to be processed by the access device, the access device can be dynamically optimized for voice calls. It should be appreciated that an infinite number of desired goals for different data traffic types being favored over other types of different data traffic types under a multitude of different conditions (e.g. time of day, week, financial market conditions, etc.) can be programmed into the optimizer.

The optimizing processing unit 242 compares the desired goal to the first and second analyzer data, which provide the current state of the access device (i.e. the data traffic flow for each data traffic type into and out of the access device), and based on the comparison, the optimizing database 244 provides optimized system parameters to the optimizing processing unit 242. The optimizing processing unit 242 processes these optimized system parameters and transmits the optimized system parameters to the core processing engine to achieve the desired goal. The optimizing database 244 can be a simple look up table, a knowledge base, a neural network, or any sort of database or algorithm, to generate and store optimized system parameter settings correlated to the state of the access device and the desired goals for the access device.

Thus, if a particular type of data traffic is present, and that particular type of data traffic is set to the highest priority relative to other data traffic types, then optimized system parameters are sent to the core processing engine to favor the processing of that particular type of data traffic over other data traffic types. As a particular example, if voice traffic is present and is the highest priority relative to other data traffic types, then optimized system parameters are sent to the core processing engine to favor the processing of voice traffic. Accordingly, the access device utilizing the analyzer and the optimizer creates a dynamic feedback loop that constantly and instantaneously, dependent upon the data traffic that the analyzer is looking at and the desired goal, dynamically changes the optimized system parameters sent to the core processing engine to achieve the desired goal, such that the access device is continuously dynamically optimized in response to the changing mixtures of the different data traffic types presented to the access device.

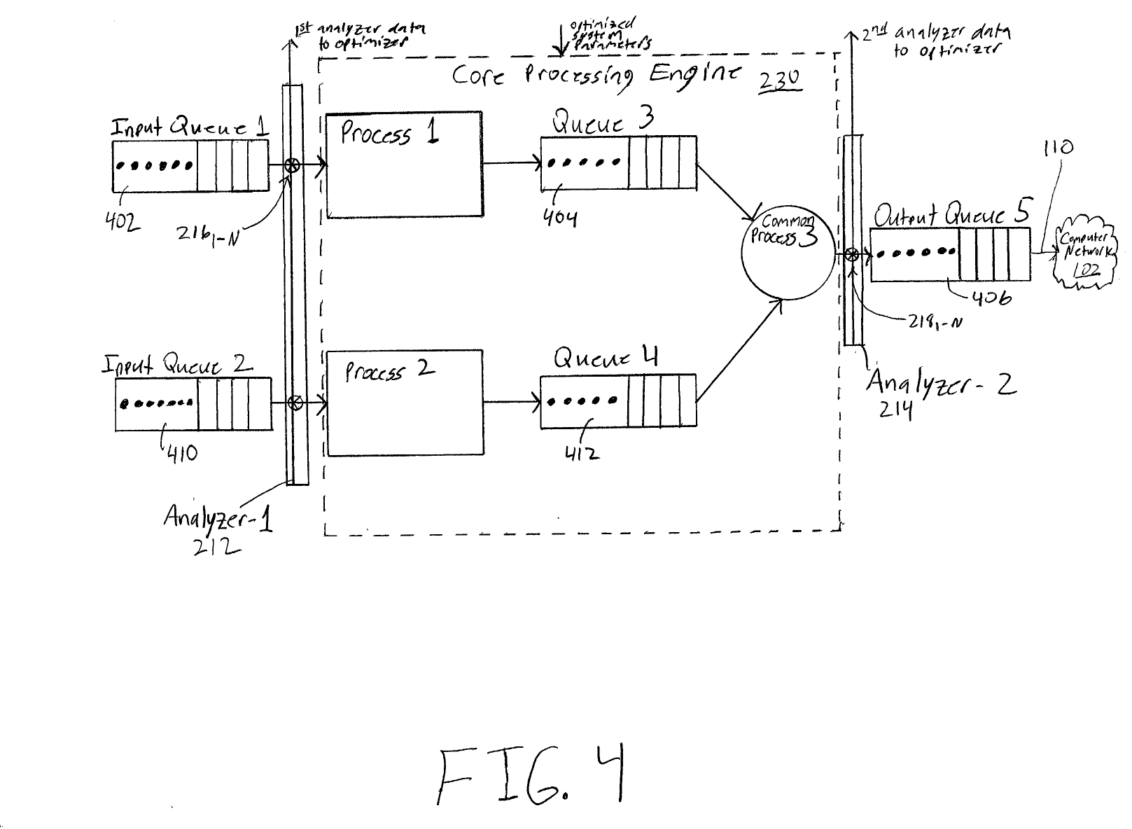

FIG. 4 is a block diagram illustrating an example of the core processing engine of the multi-service access device processing an exemplary set of data traffic according to one embodiment of the present invention. As shown in FIG. 4, a first input queue of data traffic 402 from one of the end nodes or other data traffic inputs is received by the access device. The first input queue of data traffic 402 is measured by one of the data taps 216_{1-N} of the first analyzer 212, analyzed by the first analyzer 212, and first analyzer data is transmitted to the optimizer. The first input queue of data traffic 402 next undergoes Process 1 of the core processing engine 230 resulting in a third queue of data traffic 404. The third queue of data traffic 404 then undergoes Common Process 3 (along with a fourth queue 412 of data traffic) and is transmitted out of the core processing engine as a fifth queue of data traffic 406 along network link 10 to the computer network 102. The fifth queue of data traffic 406 is also measured by one of the data taps 218_{1-N} of the second analyzer 214, analyzed by the second analyzer 214, and second analyzer data is transmitted to the optimizer.

Concurrently, a second input queue of data traffic 410 from one of the end nodes or other data traffic inputs is received by the access device. The second input queue of data traffic 410 is measured by one of the data taps 216_{1-N} of the first analyzer 212, analyzed by the first analyzer 212, and first analyzer data is transmitted to the optimizer. The second input queue of data traffic 410 next undergoes Process 2 of the core processing engine 230 resulting in a fourth queue of data traffic 412. The fourth queue of data traffic 412 then undergoes Common Process 3 (along with the third queue of data traffic 404) and is transmitted out of the core processing engine as a fifth queue of data traffic 406 along network link 110 to the computer network 102. The fifth queue of data traffic 406 is also measured by one of the data taps 218_{1-N} of the second analyzer 214, analyzed by the second analyzer 214, and second analyzer data is transmitted to the optimizer. As previously discussed, the optimizer 240 compares a desired goal to the first and second analyzer data, which provide the current state of the access device (i.e. the data traffic flow for each data traffic type into and out of the access device), and based on the comparison, the optimizer 240 provides optimized system parameters to the core processing engine 230 to achieve the desired goal for the different types of data traffic currently being processed by the core processing engine.

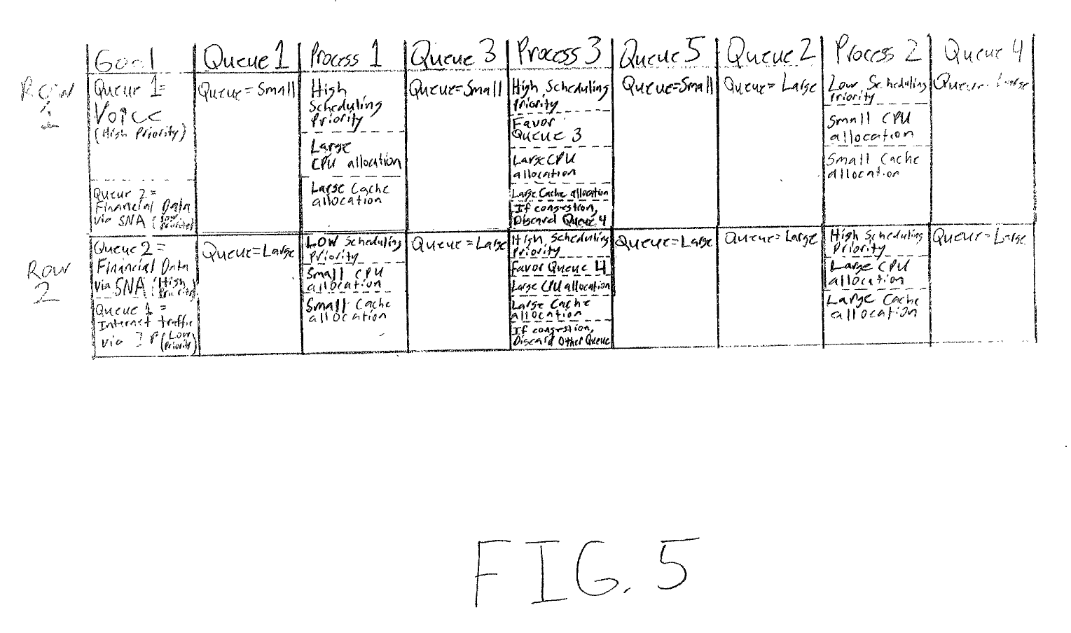

FIG. 5 is a table illustrating three different examples of how the multi-service access device of the present invention (constructed as described above) can optimize system parameters of the core processing engine for exemplary sets of data traffic and the processes shown in FIG. 4, to achieve a desired goal, according to one embodiment of the present invention. Each row of the table in FIG. 5 represents the specific optimizations for a class of data with the order of the rows determining the priority of the data. With reference to FIG. 5, in conjunction with FIG. 4, some examples of how the access device can optimize system parameters of the core processing engine to achieve a desired goal will be discussed.

For example, as shown in Row 2, a desired goal may be to favor financial transaction data traffic (via SNA), over Internet data traffic (via TCP/IP), during the day, to efficiently process high priority financial traffic data. In this way, the optimizations have been set to favor the financial transactions over say workers using the Internet for undesirable non-work related web surfing.

The second input queue of data traffic 402 for financial data transactions is set to a large value for high throughput through the core processing engine 230. Process 2 (e.g. analysis of the financial data) is set to have a high scheduling priority, a large CPU allocation for the greatest amount of processing, and a large cache memory allocation to take advantage of high speed cache memory. The output of Process 2, the fourth queue of data traffic 412 (e.g. the analyzed financial data), is likewise is set to a large value, for high throughput through the core processing engine 230. The fourth queue of data traffic 412 then undergoes Common Process 3 (e.g. packetization into a suitable protocol for transmission over computer network 102, along with the other queues of data traffic). Similarly, Common Process 3 is set to have a high scheduling priority, a large CPU allocation for the greatest amount of processing, and a large cache memory allocation to take advantage of high speed cache memory. Also, Common Process 3 favors queue 4 and a discard threshold can be set such that if congestion occurs in the access device, the other queue of data traffic (e.g. Internet traffic) is discarded. The commonly processed fourth queue of data traffic 412 is transmitted out of the core processing engine as a (e.g. packetized) fifth queue of data traffic 406 along network link 110 to the computer network 102.

On the other hand, the first input queue of data traffic 402 currently handling the less important Internet traffic (via TCP/IP) is likewise set to a large value for high throughput through the core processing engine 230. However, Process 1 (e.g. analysis of the IP data) is set to a low scheduling priority, a small CPU allocation for a smaller amount of processing, and a small cache memory allocation. The output of Process 1, the third queue of data traffic 404 (e.g. the analyzed IP data), is likewise set to a large value for high throughput through the core processing engine 230. The third queue of data traffic 404 then undergoes Common Process 3 (e.g. packetization into a suitable protocol for transmission over computer network 102, along with the fourth queue of data traffic). The commonly processed third queue of data traffic 404 is transmitted out of the core processing engine as a (e.g. packetized) fifth queue of data traffic 406 along network link 110 to the computer network 102.

The above example described the optimizations for two specific types of traffic flowing through the core processing engine. The dynamic nature of this invention is illustrated by the change of the nature of the data flowing. Row 1 of the table in FIG. 5 identifies that Voice calls are to be given the highest priority and lowest latency in the system. If, during the processing of the data streams described above a voice call is made and the Voice packets arrive via the first input queue 402, the Analyzer 212 will detect the presence of Voice packets via one of the data taps 216. This information will be sent to the Optimizer (not shown in FIG. 4) which will use the parameters stored in Row 1 of the table in FIG. 5 to dynamically reconfigure the Core Processing Engine 230 to give priority to the Voice packets.

Specifically, the following changes will be made. Process 1 (i.e. for the processing of voice traffic) will be given a higher priority than Process 2 (i.e. for the processing of financial data traffic), as well as, a large CPU allocation for the greatest amount of processing and a large cache memory allocation to take advantage of high speed cache memory. In contrast, Process 2 is changed to have a low scheduling priority, a small CPU allocation, and a small cache memory allocation. Process 2 will further be restricted to very small time slices to prevent it from blocking work needing to be done by Process 1. As before, Common Process 3 is set to have a high scheduling priority, a large CPU allocation, and a large cache memory allocation. However, common Process 3 will be instructed to now favor the input of the third queue 404 over that of the fourth queue 412 and if congestion occurs in the access device, the fourth queue of data traffic will be discarded. Moreover, the queue lengths in the first and third queues 402 and 404 (i.e. voice traffic) will be set to low values to reduce latency whereas the queue lengths for the second and fourth queues 410 and 412 (i.e. financial data traffic) remain large. The net result of these changes is to change the core processing engine from one optimized to process a high throughput of financial data traffic to one optimized for low latency voice.

Once the voice call has been completed, the Analyzer 212, via one of the data taps 216, no longer reports the presence of Voice Packets to the Optimizer and the optimizer then once again consults the table in FIG. 5 to determine how the core processing engine 230 should be configured to optimally handle the current mix of traffic.

Thus, assuming a number of voice calls suddenly need to be processed by the access device and that a desired goal is that voice calls have a high priority, the access device can suddenly switch to be dynamically optimized for voice calls. In this instance, the optimized system parameters can be dynamically changed to favor voice traffic over financial transaction data traffic. Accordingly, the access device is dynamically optimized to favor voice traffic so that the voice traffic is more likely to get through reliably without delay or latency, while putting off the financial transaction data traffic that can be processed at a later time. Thus, the access device is dynamically optimized to respond to the changing mixtures of data traffic types. Moreover, it should be appreciated that an infinite number of desired goals for different data traffic types being favored over other types of different data traffic types under a multitude of different conditions (e.g. time of day, week, financial market conditions, etc.) can be implemented.

Another advantage of the present invention is that it can be used with an access device already having a fixed hardware configuration to support increased data traffic throughput at higher quality levels than access devices not using the invention. Accordingly, lower cost access devices using the present invention can provide the same performance as higher cost access devices resulting in significant cost savings.

While the present invention and its various functional components have been described in particular embodiments, it should be appreciated the present invention can be implemented in hardware, software, firmware, middleware or a combination thereof and utilized in systems, subsystems, components, or sub-components thereof. When implemented in software, the elements of the present invention are the instructions/code segments to perform the necessary tasks. The program or code segments can be stored in a machine readable medium, such as a processor readable medium or a computer program product, or transmitted by a computer data signal embodied in a carrier wave, or a signal modulated by a carrier, over a transmission medium or communication link. The machine-readable medium or processor-readable medium may include any medium that can store or transfer information in a form readable and executable by a machine (e.g. a processor, a computer, etc.). Examples of the machine/processor-readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A multi-service access device including a core processing engine having a central processing unit (CPU) and a memory connected to a computer network, the access device comprising:
an analyzer to analyze a current mixture of a plurality of different data traffic types and to create analyzer data; and
an optimizer coupled to the analyzer, the optimizer to optimize system parameters of the access device based upon the analyzer data such that the access device is dynamically optimized in response to changing mixtures of different data traffic types.

2. The access device of claim 1 wherein the analyzer includes a plurality of data taps, each data tap associated with a particular data traffic type to acquire information about the particular data traffic type.

3. The access device of claim 2 wherein the analyzer includes an analyzer processing unit to process information about the plurality of different data traffic types based upon the acquired information from the plurality of data taps to generate the analyzer data.

4. The access device of claim 1 wherein the optimizer includes an optimizing processing unit to process the analyzer data received from the analyzer and to generate optimized system parameters for the core processing engine of the access device such that the access device is dynamically optimized in response to changing mixtures of different data traffic types.

5. The access device of claim 4 wherein the optimizer further includes an optimizing database coupled to the optimizing processing unit that includes optimized system parameters for different mixtures of data traffic types to achieve a desired goal.

6. The access device of claim 5 wherein the optimized system parameters include at least one of scheduling priority, queue size, CPU allocation, memory allocation, discard priority, or message size.

7. The access device of claim 6 wherein if the desired goal is to favor voice traffic the optimized system parameters are set such that the scheduling priority for voice traffic is set to a high value, queue size for voice traffic is set to a small value, CPU allocation for voice traffic is set to a large value, and the discard priority for other types of data traffic is set to a high value.

8. The access device of claim 6 wherein if the desired goal is to favor a type of data traffic, the optimized system parameters are set such that the scheduling priority for the type of data traffic is set to a high value, queue size for the type of data traffic voice traffic is set to a high value, CPU allocation for the type of data traffic is set to a large value, memory allocation for the type of data traffic is set to a large value, and the discard priority for other types of data traffic is set to a high value.

9. The access device of claim 1 wherein the data traffic types include at least one of voice, video, fax, TCP/IP network protocol, Asynchronous Transfer Mode (ATM) protocol, Frame Relay (FR) protocol, or Voice over IP (VoIP) protocol.

10. The access device of claim 1 wherein the access device is connected between a plurality of individual data traffic inputs and a data link input from a computer network, the access device further comprising:
a first analyzer to analyze a current mixture of a plurality of different data traffic types from the plurality of individual traffic inputs and to create first analyzer data; and
a second analyzer to analyze a current mixture of a plurality of different data traffic types from the data link input from the computer network and to create second analyzer data; and
wherein the optimizer is coupled to both the first and second analyzer, the optimizer to optimize system parameters of the access device based upon the first and second analyzer data such that the access device is dynamically optimized in response to changing mixtures of different data traffic types.

11. A method to dynamically optimize a multi-service access device comprising:
analyzing a current mixture of a plurality of different data traffic types;
generating analyzed data; and
optimizing system parameters of the access device based upon the analyzed data such that the access device is dynamically optimized in response to changing mixtures of different data traffic types.

12. The method of claim 11 wherein analyzing the current mixture of the different data traffic types includes acquiring information about each particular data traffic type.

13. The method of claim 12 wherein generating the analyzed data includes processing the acquired information about each particular data traffic type.

14. The method of claim 11 wherein optimizing system parameters of the access device includes processing the analyzed data to generate optimized system parameters for a core processing engine of the access device such that the core processing engine is dynamically optimized in response to changing mixtures of different data traffic types.

15. The method of claim 14 further comprising utilizing an optimizing database to retrieve optimized system parameters for different mixtures of data traffic types to achieve a desired goal.

16. The method of claim 15 wherein the optimized system parameters include at least one of scheduling priority, queue size, CPU allocation, memory allocation, discard priority, or message size.

17. The method of claim 16 wherein if the desired goal is to favor voice traffic the optimized system parameters are set such that the scheduling priority for voice traffic is set to a high value, queue size for voice traffic is set to a small value, CPU allocation for voice traffic is set to a large value, and the discard priority for other types of data traffic is set to a high value.

18. The method of claim 16 wherein if the desired goal is to favor a type of data traffic, the optimized system parameters are set such that the scheduling priority for the type of data traffic is set to a high value, queue size for the type of data traffic voice traffic is set to high value, CPU allocation for the type of data traffic is set to a large value, memory allocation for the type of data traffic is set to a large value, and the discard priority for other types of data traffic is set to a high value.

19. The method of claim 11 wherein the data traffic types include at least one of voice, video, fax, TCP/IP network protocol, Asynchronous Transfer Mode (ATM) protocol, Frame Relay (FR) protocol, or Voice over IP (VoIP) protocol.

20. A machine-readable medium having stored thereon instructions, which when executed by a processor, causes the processor to perform operations to dynamically optimize a multi-service access device comprising:
analyzing a current mixture of a plurality of different data traffic types;
generating analyzed data; and
optimizing system parameters of the access device based upon the analyzed data such that the access device is dynamically optimized in response to changing mixtures of different data traffic types.

21. The machine-readable medium of claim 20 wherein analyzing the current mixture of the different data traffic types includes acquiring information about each particular data traffic type.

22. The machine-readable medium of claim 21 wherein generating the analyzed data includes processing the acquired information about each particular data traffic type.

23. The machine-readable medium of claim 20 wherein optimizing system parameters of the access device includes processing the analyzed data to generate optimized system parameters for a core processing engine of the access device such that the core processing engine is dynamically optimized in response to changing mixtures of different data traffic types.

24. The machine-readable medium of claim 23 further comprising utilizing an optimizing database to retrieve optimized system parameters for different mixtures of data traffic types to achieve a desired goal.

25. The machine-readable medium of claim 24 wherein the optimized system parameters include at least one of scheduling priority, queue size, CPU allocation, memory allocation, discard priority, or message size.

26. The machine-readable medium of claim 25 wherein if the desired goal is to favor voice traffic the optimized system parameters are set such that the scheduling priority for voice traffic is set to a high value, queue size for voice traffic is set to a small value, CPU allocation for voice traffic is set to a large value, and the discard priority for other types of data traffic is set to a high value.

27. The machine-readable medium of claim 25 wherein if the desired goal is to favor a type of data traffic, the optimized system parameters are set such that the scheduling priority for the type of data traffic is set to a high value, queue size for the type of data traffic voice traffic is set to a high value, CPU allocation for the type of data traffic is set to a large value, memory allocation for the type of data traffic is set to a large value, and the discard priority for other types of data traffic is set to a high value.

28. The machine-readable medium of claim 20 wherein the data traffic types include at least one of voice, video, fax, TCP/IP network protocol, Asynchronous Transfer Mode (ATM) protocol, Frame Relay (FR) protocol, or Voice over IP (VoIP) protocol.
